(19) United States
(12) Patent Application Publication
(10) Pub. No.: US 2026/0094558 A1
(43) Pub. Date: Apr. 2, 2026

(54) OPTOELECTRONIC DEVICE

(71) Applicant: Aledia, Echirolles (FR)

(72) Inventors: Jaehoon Lee, Grenoble (FR); Frédéric Mercier, Coublevie (FR)

(73) Assignee: Aledia, Echirolles (FR)

(21) Appl. No.: 19/114,147

(22) PCT Filed: Sep. 28, 2023
(86) PCT No.: PCT/EP2023/076840

§ 371 Date: Mar. 21, 2025

(30) Foreign Application Priority Data
Sep. 29, 2022 (FR) FR2209863

(51) Int. Cl. G09G 3/32

(52) U.S. Cl. CPC G09G 3/32; G09G 2320/0233; G09G 2320/0693; G09G 2360/145

(57) ABSTRACT

A pixel including: a light emitting element and a first transistor coupled in series between a reference node and a supply node; and a first circuit including a first terminal coupled to the control terminal of the first transistor, a second terminal coupled to the reference node, the first circuit being configured to generate a control voltage on the first terminal, the first circuit including a variable voltage divider configured to provide the control voltage on the first terminal; and a first switch coupled between the first terminal of the first circuit and a conductive terminal of the first transistor.

The present application claims the priority benefit of French patent application number FR2209863, which is hereby incorporated by reference to the maximum extent allowable by law.

### TECHNICAL FIELD

The present disclosure relates generally to optoelectronic device, more particularly to devices comprising pixels, and their drivers.

### BACKGROUND ART

A pixel of an image corresponds to the unit element of the image displayed by a display screen. For the display of color images, the display screen generally comprises, for the display of each pixel of the image, at least three components, also called display sub-pixels, which each emit a light radiation, called image pixel color component substantially in a single color (for example, red, green, and blue). The superposition of the image pixel color components emitted by the three display sub-pixels provides the observer with the colored sensation corresponding to the pixel of the displayed image. In this case, the assembly formed by the three display sub-pixels used for the display of a pixel of an image is called display pixel of the display screen. Each display sub-pixel may comprise a light source, particularly a light-emitting diode.

The display pixels may be distributed in an array, each display pixel being located at the intersection of a row (also called line) and of a column of the array. Each display pixel for example comprises a light emitting element and associated electronics, for example a driver. Electrodes are provided along the rows and the columns to connect each display pixels to control circuits. Generally, each row of display pixels is successively selected by a signal ROW transmitted along the row electrodes, and the display pixels of the selected row are programmed to display the desired image pixels by signals COL transmitted along the column electrodes.

Each generation of screen comprises more display pixel, in order to provide a more detailed image. However, the increased number of display pixel and therefore, the increase number of associated electronics, creates an important static current and an increased consumption of energy.

### SUMMARY OF INVENTION

One embodiment addresses all or some of the drawbacks of known optoelectronic devices.

There is a need for an optoelectronic device generating less static current.

There is need of a more compact pixel driver.

There is a need to optimize the control voltage of transistors in pixels.

An embodiment provides a pixel comprising:
a light emitting element and a first transistor coupled in series between a reference node and a supply node; and
a first circuit comprising a first terminal coupled to the control terminal of the first transistor, a second terminal coupled to the reference node, the first circuit being configured to generate a control voltage on the first terminal, the first circuit comprising a variable voltage divider configured to provide the control voltage on the first terminal, the variable voltage divider comprising two capacitive branches, the proportion between the branches being variable; and
a first switch coupled between the first terminal of the first circuit and a conductive terminal of the first transistor. Such a structure allows to diminish the static current and to diminish the size of the pixels.

According to an embodiment, the voltage divider comprises a first capacitor coupled between the first and second terminals of the first circuit.

According to an embodiment, the first circuit comprises a third terminal coupled to a node of application of a data signal.

According to an embodiment, the voltage divider comprises a second capacitor coupled between the first terminal of the first circuit and the third terminal of the first circuit.

According to an embodiment, the pixel comprises a second switch coupled between the second terminal of the first circuit and a third switch coupled between the second capacitor and the third terminal of the first circuit.

According to an embodiment, the voltage divider comprises at least one third capacitor, the third capacitor being configured to be coupled between the first terminal and either the second or the third terminal, depending on a control voltage.

According to an embodiment, each at least one third capacitor is coupled in series with a fourth switch, one terminal of the second capacitor being coupled to the first terminal of the first circuit, the second terminal of the second capacitor being coupled to a first terminal of the fourth switch, the fourth switch comprising a second terminal coupled to the second terminal of the first circuit and the fourth switch comprising a third terminal coupled to the third terminal of the first circuit.

According to an embodiment, the first circuit comprises at least two assembly of a second capacitor coupled in series with a fourth switch, the fourth switches being controlled by different control voltages.

According to an embodiment, the first transistor and the element are coupled in series with a fifth switch.

According to an embodiment, the first circuit comprises a sixth switch coupled between the control terminal of the transistor and a node of application of a reset voltage.

Another embodiment provides a display screen comprising a plurality of pixels as described before.

According to an embodiment, the pixels are disposed in an array and the third terminal of each first circuit is configured to receive a voltage common to all the pixels of a same row.

According to an embodiment, the light emitting elements are coupled with a common cathode, the elements of each pixel being coupled between the first transistor of said pixel and the reference node.

Another embodiment provides a method of controlling a pixel as previously described, comprising:
a first phase during which the first switch is closed and the capacitors of the voltage dividers coupled between the first and second terminals of the first circuit are charged, and
a second phase during which the first switch is open.

According to an embodiment, the method comprises an alternance of first and second phases.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 illustrates an example of optoelectronic device;

FIG. 2 illustrates, schematically, an example of a pixel;

FIG. 3 illustrates, in more detail, a part of the pixel of FIG. 2 according to an embodiment;

FIG. 4 illustrates, in more detail, a part of the pixel of FIG. 2 according to the embodiment of FIG. 3;

FIG. 5 illustrates an operation of the embodiment of FIG. 3;

FIG. 6 illustrates another operation of the embodiment of FIG. 3;

FIG. 7 illustrates another operation of the embodiment of FIG. 3;

FIG. 8 illustrates in more details the different operations of the embodiment of FIG. 3;

FIG. 9 illustrates, in more detail, a part of the device of FIG. 2 according to another embodiment;

FIG. 10 illustrates, in more detail, a part of the pixel of FIG. 2 according to the embodiment of FIG. 9;

FIG. 11 illustrates an operation of the embodiment of FIG. 9;

FIG. 12 illustrates another operation of the embodiment of FIG. 9;

FIG. 13 illustrates another operation of the embodiment of FIG. 9; and

FIG. 14 illustrates the operations of the embodiment of FIG. 9.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front” , “back”, “top” , “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

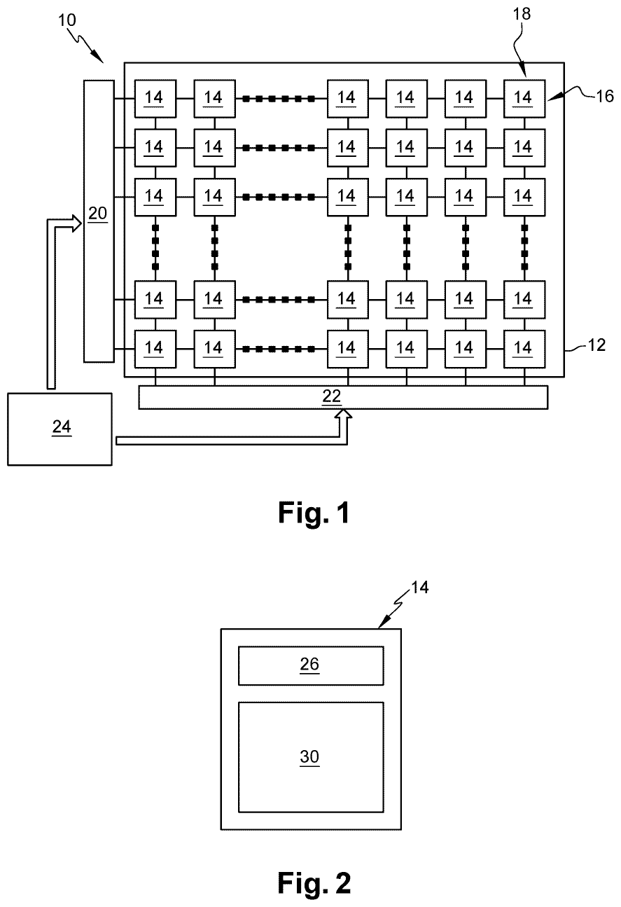

FIG. 1 illustrates an example of optoelectronic device 10.

The device 10 comprises a screen 12. The screen 12 is for example configured to project light, pictures or videos. The screen comprises an array of pixels 14. The screen 12 for example comprises at least one million pixels, for example at least two million pixels, for example at least eight million pixels. The screen comprises rows 16 of pixels 14 and columns 18 of pixels 14.

The device 10 further comprises a row control circuit, or driver, 20 and a column control circuit, or driver, 22. The circuit 20 is configured to provide row voltages ROW, in other words to provide control voltages common to all the pixels of a same row. Similarly, the circuit 22 is configured to provide column voltages COL, in other words to provide control voltages common to all the pixels of a same column. For example, the voltage ROW corresponds to the line selection and to the clock signal in illumination mode, for example in pulse width modulation (PWM) mode. For example, the voltage COL corresponds to the illumination data, for example video data.

The device 10 for example comprises a controller 24 configured to provide the circuits 20 and 22 the data to generate the voltages ROW and COL. The controller 24 can also provide the clock signal to the circuits 20 and 22, and eventually to the pixels 14. The controller 24 is for example a timing controller.

FIG. 2 illustrates, schematically, an embodiment of a pixel 14. The pixel 14 comprises a region 26, and a region 30.

The region 26 comprises at least one light emitting element. For example, the light emitting element is, in the rest of the description, a light emitting diode. However, the light emitting element can be any kind of light emitting component. The region 26 comprises for example three light emitting diodes, a diode configured to provide blue light, a diode configured to provide green light, a diode configured to provide red light.

The region 30 is for example the pixel driver. The region 30 comprises analog and digital circuits. The region 30 comprises peripheral circuits. The region 30 comprises for example a power circuit, configured to provide the supply voltages of the pixels. The region 30 comprises for example control logic.

For example, each pixel comprises only four input pads, not represented. In other words, each pixel only receives four external voltages: a supply voltage, a reference voltage, for example the ground GND, a signal ROW transmitted along the row electrodes, and a signal COL transmitted along the column electrodes.

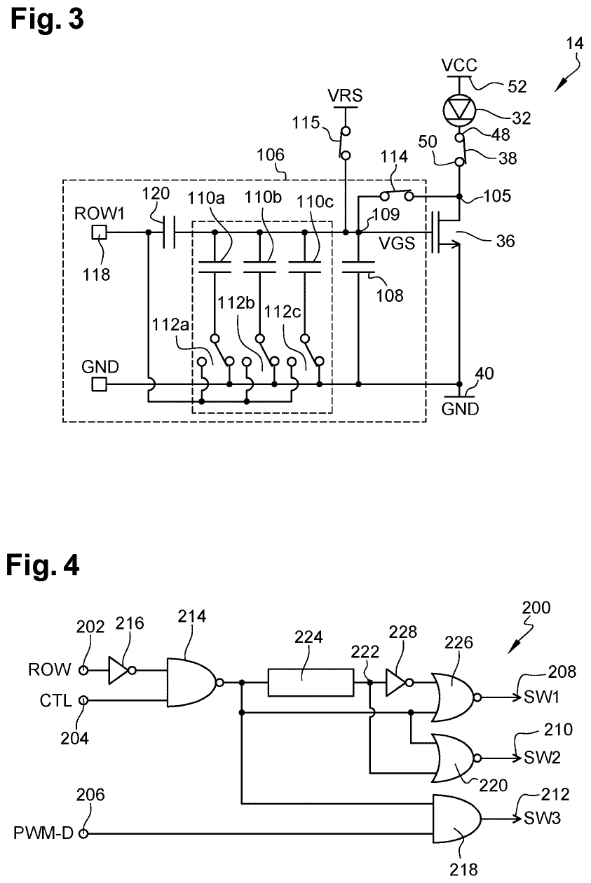

FIG. 3 illustrates, in more detail, a part of the pixel 14 of FIG. 2 according to an embodiment. In the example of FIG. 3, the pixel is configured to be coupled with other pixels in common anode.

The pixel 14 comprises a light emitting diode 32. The diode 32 is coupled in series with a transistor 36 and a switch 38 between a node 52 of application of a supply voltage VCC of the pixel and a node 40 of application of a reference voltage, for example the ground GND. The transistor 36 is for example a metal-oxide-semiconductor field-effect transistor (MOSFET), for example a p-channel transistor. The transistor 36 comprises a control terminal, for example a gate, and two conduction terminals, for example a drain and a source. The switch 38 comprises two terminals 48 and 50.

The diode 32, the switch 38 and the transistor 36 are coupled in series, between the node 52 and the node 40. The diode 32, the transistor 36 and the switch 38 are coupled so that the diodes of different pixels can be coupled with a common anode. The diode 32 is coupled between the node 52 and the switch 38. In other words, the anode of the diode 32 is coupled, preferably connected, to the node 52 and the cathode of the diode 32 is coupled, preferably connected, to the terminal 48 of the switch 38. The terminal 50 of the switch 38 is coupled to the node 40 by the transistor 36. In other words, the terminal 50 of the switch 38 is coupled, preferably connected, to a node 105, the node 105 being coupled, preferably connected, to a conductive terminal, for example the drain of the transistor 36 and the other conductive terminal, for example the source, of the transistor 36 is coupled, preferably connected, to the node 40.

The control terminal of the transistor 36 is coupled, preferably connected, to a circuit 106 configured to generate the voltage VGS.

The circuit 106 comprises a variable capacitive voltage divider. In other words, the circuit 106 comprises a voltage divider wherein the proportion between the two capacitive branches is variable.

The voltage divider, and therefore the circuit 106, comprises a capacitor 108. The capacitance of the capacitor 108 is preferably constant. The capacitor 108 is coupled between the control terminal of the transistor 36 and the node 40. A first terminal of the capacitor 108 is coupled, preferably connected, to a node 109, the node 109 being coupled, preferably connected, to the control terminal of the transistor 36. A second terminal of the capacitor 108 is coupled, preferably connected, to the node 40.

The control terminal of the transistor 36 is further coupled to a node 118 of application of a voltage ROW1 generated from the voltage ROW. The control terminal of the transistor 36 is coupled to the node 118 by a capacitor 120. The capacitance of the capacitor 120 is preferably constant. More precisely, the control terminal of the transistor 36 is coupled, preferably connected, to a terminal of the capacitor 120. In other words, said terminal of the capacitor 120 is coupled, preferably connected, to the node 109. Another terminal of the capacitor 120 is coupled, preferably connected, to the node 118.

The voltage divider also comprises at least one capacitor 110 coupled in parallel with either the capacitor 108 or the capacitor 120, depending on a control signal. The capacitance of the capacitors 110 are for example constant. The capacitance of the capacitors 110 are for example substantially equal.

In the example of FIG. 3, the divider comprises three capacitors 110, referenced 110a, 110b and 110c. In general, the number of capacitors 110 depend on the application.

Each capacitor 110 is coupled in series with a switch 112. In other words, the capacitor 110a is coupled in series with a switch 112a, the capacitor 110b is coupled in series with switch 112b, and the capacitor 110c is coupled in series with a switch 112c.

A terminal of each capacitor 110 is coupled, preferably connected, to the node 109. Another terminal of each capacitor 110 is coupled, preferably connected, to an input terminal of the corresponding switch 112. Each switch 112 comprises a first output terminal coupled, preferably connected, to the node 40 and a second output terminal coupled, preferably connected, to the node 118. Each switch 112 is configured to connect the corresponding capacitor 110 to either the node 40 or the node 118 depending on a control voltage. Each switch 112 is preferably controlled by its own control voltage, for example independent from the control voltages of the other switches 112.

The value of the voltage VGS is therefore determined by the control voltages of the switches 112, which determines the quotient of the capacitance of the two branches of the voltage divider.

The circuit 106 further comprises a switch 114 coupled between the node 109 and the node 105. The circuit 106 further comprises a switch 115 coupled between the node 109 and a node 111 of application of a reset voltage VRS.

The switch 115 comprises a control terminal, for example coupled, preferably connected, to a node of application of a control voltage SW1. The switch 115 is configured to be used to reset the voltage divider. The switch 114 comprises a control terminal, for example coupled, preferably connected, to a node of application of a control voltage SW2.

The control terminal of the switch 38 is for example coupled, preferably connected, to a node of application of a control voltage SW3.

The circuit of FIG. 3 for example comprises a step of calibration, wherein known values of capacitance are given to the branches of the voltage divider. The capacitors coupled between the nodes 109 and 40 are charged, a voltage CTL, not represented in FIG. 3, having the first value. The voltage CTL then takes the second value and the voltage VGS determined by the capacitive divider is applied to the transistor 36. The diode is then illuminated by known data. The brightness of the diode is measured and compared with the wanted brightness. The values of the control voltages of the switches 112 are modified according to the difference between the wanted brightness and the measured brightness. The brightness of the diode is measured again. The calibration step can for example be applied again in order to further correct the value of the brightness of the diode.

FIG. 4 illustrates, in more detail, an example of implementation of a part of the pixel of FIG. 2 according to the embodiment of FIG. 3. More precisely, FIG. 4 illustrates s a circuit 200 of generation of the control voltages SW1, SW2 and SW3.

The control voltages SW1, SW2 and SW3 are obtained from the signal ROW, the voltage CTL and a voltage PWM-D.

The voltage CTL indicates that the driver is in the PWM mode. In other words, the voltage CTL is for example a binary value and takes a first value when the driver is in the PWM mode and another value when the driver is in a video data writing mode. The voltage PWM-D corresponds for example to a binary signal. The voltage PWM-D corresponds to the data for the PWM mode.

The circuit 200 comprises an input node 202, configured to receive the signal ROW, an input node 204, configured to receive the voltage CTL, and an input node 206, configured to receive the signal PWM-D. The circuit 200 comprises an output node 208, on which is applied the voltage SW1, an output node 210, on which is applied the voltage SW2, and an output node 212, on which is applied the voltage SW3.

The circuit 200 comprises a logic gate NAND 214. A first input of the gate 214 is coupled, preferably connected, to the node 204. A second input of the gate 214 is coupled to the node 202 by an inverter 216. In other words, the input of the inverter 216 is coupled, preferably connected, to the node 202 and the output of the inverter 216 is coupled, preferably connected, to the second input of the gate 214.

The circuit 200 comprises a logic gate AND 218. An output of the gate 218 is coupled, preferably connected, to the node 212. A first input of the gate 218 is coupled, preferably connected, to the node 206. A second input of the gate 218 is coupled, preferably connected, to an output of the logic gate 214.

The circuit 200 comprises a logic gate NOR 220. An output of the gate 220 is coupled, preferably connected, to the node 210. A first input of the gate 220 is coupled, preferably connected, to the output of the logic gate 214. A second input of the gate 220 is coupled to a node 222. The node 222 is coupled to the output of the logic gate 214 by a delay circuit 224. In other words, a terminal of the delay circuit 224 is coupled, preferably connected, to the output of the gate 214 and the other terminal of the delay circuit 224 is coupled, preferably connected, to the node 222.

The circuit 200 comprises a logic gate NOR 226. An output of the logic gate 226 is coupled, preferably connected, to the: node 208. A first input of the gate 226 is coupled, preferably connected, to the output of the gate 214. A second input of the gate 226 is coupled to the node 222 by an inverter 228. In other words, the input of the inverter 228 is coupled, preferably connected, to the node 222 and the output of the inverter 228 is coupled, preferably connected, to the second input of the gate 226.

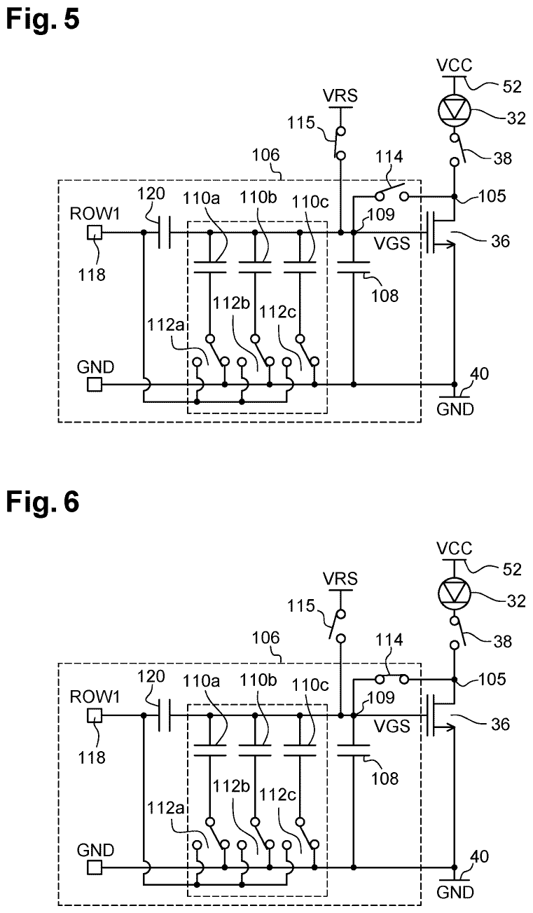

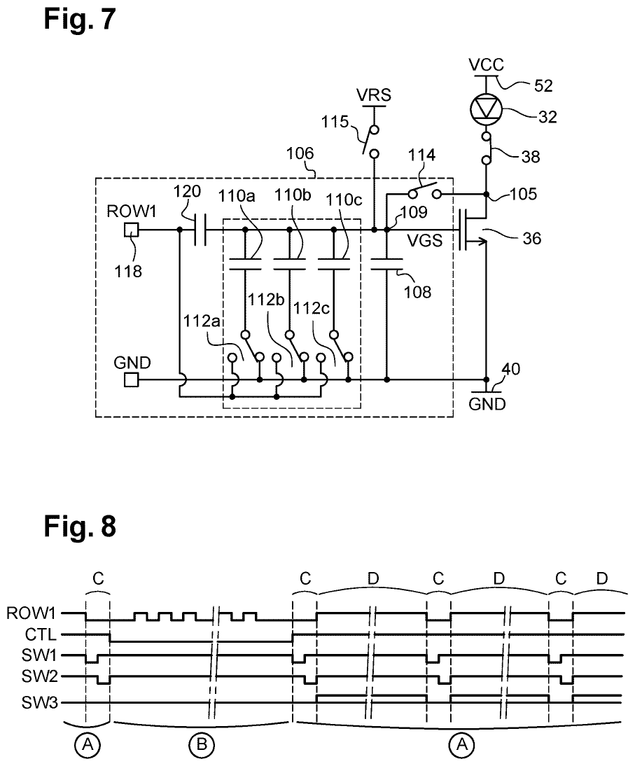

FIGS. 5, 6 and 7 illustrates successive steps of the operation of the pixel. FIGS. 5 and 6 illustrates the refreshing of the driver. FIG. 7 illustrates the PWM mode. The refreshing is preferably applied regularly during the PWM driving of the pixel, for example before the transmission of every data.

FIG. 5 illustrates an operation of the embodiment of FIG. 3. More precisely, FIG. 5 illustrates a reset step.

During this step, the control voltages SW1, SW2 and SW3 are such that the switch 115 is close, the switch 114 is open and the switch 38 is open. The voltage on the gate of the transistor 36 is therefore substantially equal to the reset value VRS.

FIG. 6 illustrates another operation of the embodiment of FIG. 3. FIG. 6 illustrates a programming step.

During this step, the control voltages SW1, SW2 and SW3 are such that the switch 115 is open, the switch 114 is close and the switch 38 is open. The voltage on the gate of the transistor 36 is therefore substantially equal to the threshold value Vth of the transistor 36.

FIG. 7 illustrates another operation of the embodiment of FIG. 3. This operation corresponds to the PWM mode.

During this step, the control voltages SW1, SW2 and SW3 are such that the switch 115 is open, the switch 114 is open. The switch 38 is open and close depending on the PWM data. the voltage on the gate of the transistor 36 is dependent on the signal ROW1.

FIG. 8 illustrates in more details the different operations of the embodiment of FIG. 3. More precisely, FIG. 8 illustrates the signal ROW1, the voltage CTL, the control voltage SW1, the control voltage SW2 and the control voltage SW3 during the PWM mode (A) and the video data writing mode (B).

During the video data writing mode (B), the voltage CTL takes a low value, indicating, in this example, that the pixel is not in PWM mode. Furthermore, the voltages SW1, SW2 and SW3 respectively have a high value, a high value and a low value. The switches 115, 114 and 38 are open. The signal ROW1 corresponds to a clock signal for the writing of the data, received on the signal COL.

The PWM mode (A) comprises an alternance of periods (C) and (D).

During each period (D), the light emitting element 32 is enlightened according to at least one data, for example a single data. Each period (D) corresponds to the step of FIG. 7. Therefore, the voltages SW1, SW2 both have a high value, corresponding to an open state. The voltage SW3 is such that the switch 38 is opened and closed depending on the programmed illumination of the pixel. The voltage CTL has a high value indicating the PWM mode. The signal ROW1 has a high value.

The periods (C) correspond to the refreshing of the driver, in other words to the successive steps of FIGS. 5 and 6. During the beginning of the period (C), in other words during the step of FIG. 5, the signal ROW1 has a low value, the voltage CTL has a high value, the voltage SW1 has a low value, the voltage SW2 has a high value and the voltage SW3 has a low value. During the rest of the period (C), in other words during the step of FIG. 6, the signal ROW1 has a low value, the voltage CTL has a high value, the voltage SW1 has a high value, the voltage SW2 has a low value and the voltage SW3 has a low value.

Preferably, the periods (C) have an identical duration. The periods (D) have for example an identical duration. Alternatively, the periods (D) are binary weighted periods. In other words, some duration of periods (D) are equal to 1/(2\hat{ }n) times the maximum value of the duration of the period (D), n being a positive integer value. Alternatively, the periods (C) occur for example periodically in the PWM mode (A).

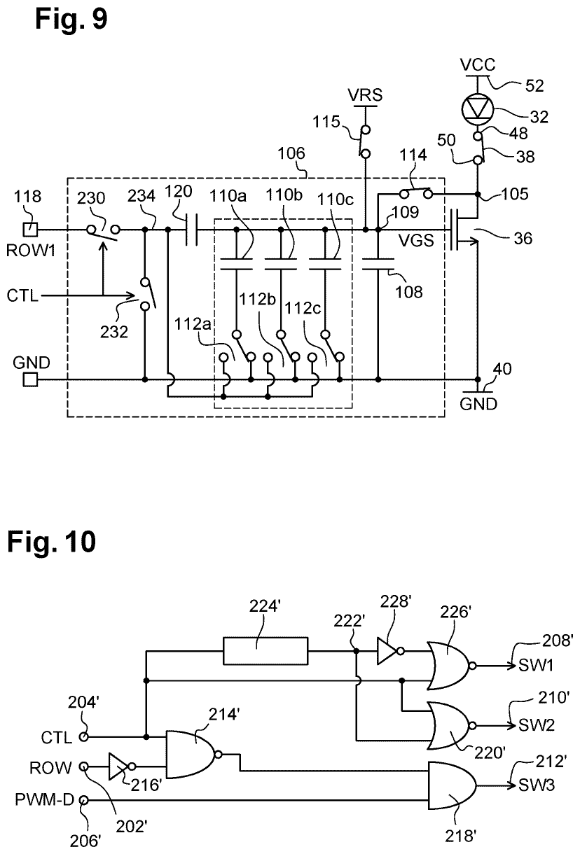

FIG. 9 illustrates, in more detail, a part of the device of FIG. 2 according to another embodiment.

The embodiment of FIG. 9 differs from the embodiment of FIG. 3 in that the embodiment of FIG. 9 comprises a switch 230 and a switch 232.

The switch 230 is coupled in series with the capacitor 120 between the node 109 and the node 118. In other words, a terminal of the capacitor 120 is coupled, preferably connected, to the node 109 and the other terminal of the capacitor 120 is coupled, preferably connected, to a node 234. A terminal of the switch 230 is coupled, preferably connected, to the node 234 and the other terminal of the switch 230 is coupled, preferably connected, to the node 118.

The switch 232 is couple between the nodes 40 and 234. In other words, a terminal of the switch 232 is coupled, preferably connected, to the node 234 and another terminal of the switch 232 is coupled, preferably connected, to the node 40.

The switches 230 and 232 are configured to have opposite states. In other words, when one of the switches 230 and 232 is opened, the other is closed. The switch 230 comprises a control terminal configured to receive a control voltage SW4. The switch 232 comprises a control terminal configured to receive a control voltage SW4′. The control voltages SW4 and SW4′ are for example complimentary binary voltages. The voltage SW4 is for example equal to the voltage CTL.

FIG. 10 illustrates, in more detail, a part of the pixel of FIG. 2 according to the embodiment of FIG. 9. More precisely, FIG. 4 illustrates a circuit 200 of generation of the control voltages SW1, SW2 and SW3.

The control voltages SW1, SW2 and SW3 are obtained from the signal ROW, a voltage CTL and a voltage PWM-D.

The circuit 200 comprises an input node 202′, configured to receive the signal ROW, an input node 204′, configured to receive the voltage CTL, and an input node 206′, configured to receive the signal PWM-D. The circuit 200 comprises an output node 208′, on which is applied the voltage SW1, an output node 210′, on which is applied the voltage SW2, and an output node 212′, on which is applied the voltage SW3.

The circuit 200 comprises a logic gate NAND 214′. A first input of the gate 214′ is coupled, preferably connected, to the node 204′. A second input of the gate 214′ is coupled to the node 202′ by an inverter 216′. In other words, the input of the inverter 216′ is coupled, preferably connected, to the node 202′ and the output of the inverter 216′ is coupled, preferably connected, to the second input of the gate 214′.

The circuit 200 comprises a logic gate AND 218′. An output of the logic gate 218′is coupled, preferably connected, to the node 212′. A first input of the gate 218′ is coupled, preferably connected, to the node 206′. A second input of the gate 214′ is coupled, preferably connected, to an output of the logic gate 214′.

The circuit 200 comprises a logic gate NOR 220′. An output of the logic gate 220′ is coupled, preferably connected, to the node 210′. A first input of the gate 220′ is coupled, preferably connected, to the node 204′. A second input of the gate 220′ is coupled to a node 222′. The node 222′ is coupled to the node 204′ by a delay circuit 224′. In other words, a terminal of the delay circuit 224′ is coupled, preferably connected, to the node 204′ and the other terminal of the delay circuit 224′ is coupled, preferably connected, to the node 222′.

The circuit 200 comprises a logic gate NOR 226′. An output of the logic gate 226′ is coupled, preferably connected, to the node 208′. A first input of the gate 226′ is coupled, preferably connected, to the node 204′. A second input of the gate 226′ is coupled to the node 222′ by an inverter 228′. In other words, the input of the inverter 228′ is coupled, preferably connected, to the node 222′ and the output of the inverter 228′ is coupled, preferably connected, to the second input of the gate 226′.

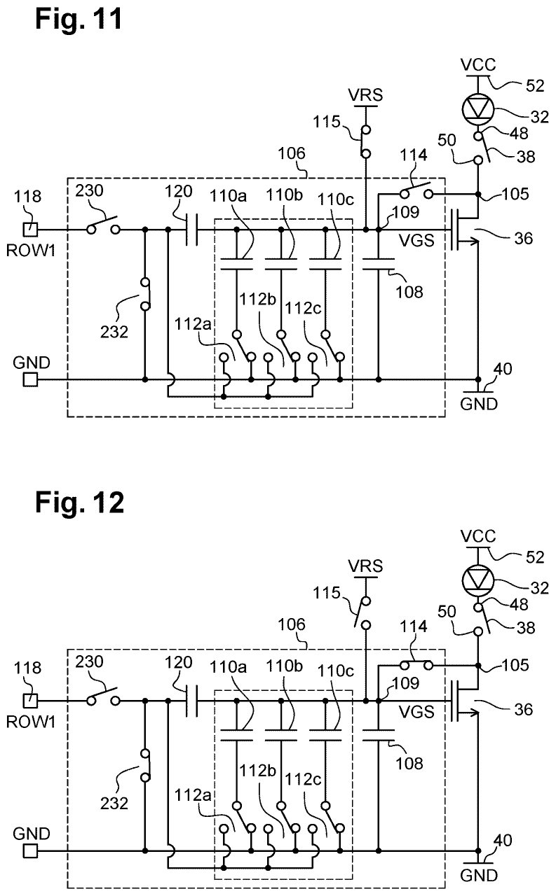

FIGS. 11, 12 and 13 illustrates successive steps of the operation of the pixel.

FIG. 11 illustrates an operation of the embodiment of FIG. 9. More precisely, FIG. 11 illustrates a reset step.

During this step, the control voltages SW1, SW2, SW3 and SW4 are such that the switches 38, 114 and 230 are open and that the switches 115 and 232 are closed. The voltage on the gate of the transistor 36 is therefore substantially equal to the reset value VRS.

FIG. 12 illustrates another operation of the embodiment of FIG. 9. FIG. 12 illustrates a programming step.

During this step, the control voltages SW1, SW2, SW3 and SW4 are such that the switches 38, 115 and 230 are open and that the switches 114 and 232 are closed. The voltage on the gate of the transistor 36 is therefore substantially equal to the value Vth of the transistor 36.

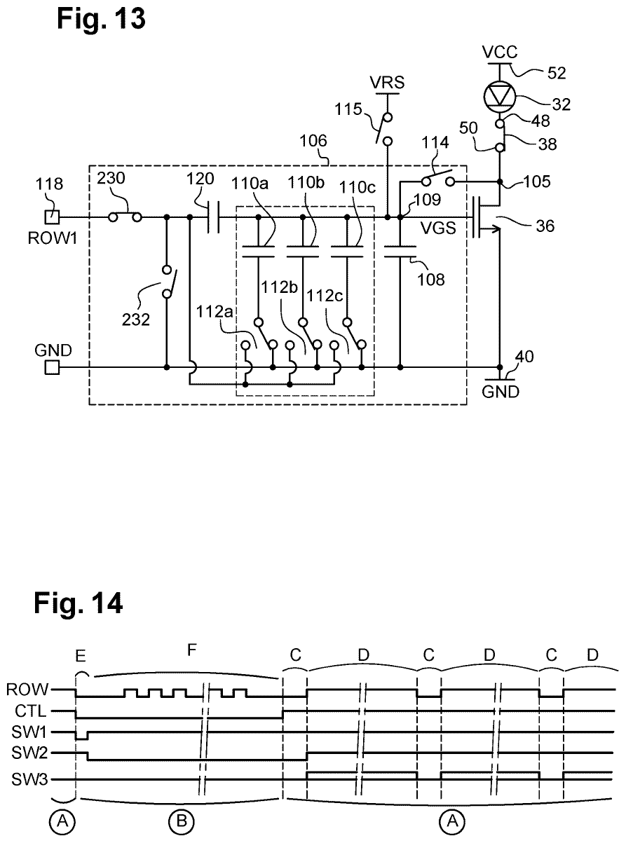

FIG. 13 illustrates another operation of the embodiment of FIG. 9. This operation corresponds to the PWM mode.

During this step, the control voltages SW1, SW2, SW3 and SW4 are such that the switches 114, 115 and 232 are open and that the switch 230 is closed. The switch 38 is open and close depending on the PWM data. The voltage on the gate of the transistor 36 is dependent on the signal ROW1.

FIG. 14 illustrates the operations of the embodiment of FIG. 9. More precisely, FIG. 14 illustrates the signal ROW1, the voltage CTL, in other words the control voltage SW4, the control voltage SW1, the control voltage SW2 and the control voltage SW3 during the PWM mode (A) and the video data writing mode (B).

During the PWM mode, the control voltages SW1 and SW2 are kept at a high value. In other words, the switches 115 and 114 are kept both closed. The voltage CTL, in other words the voltage SW4 is kept at a high value. Therefore, the switches 230 and 232 are respectively kept closed and opened during the PWM mode. The signal ROW is kept, during periods (C), a low value, and during periods (D), a high value. The periods (c) occur for example periodically during the PWM mode (A). During the periods (C), the voltage SW3 is kept at a low value, corresponding to an open state for the switch 38. During the periods (D), the voltage SW3 alternates between high and low value depending on the wanted illumination of the pixel.

The PWM mode (A) comprises an alternance of periods (C) and (D). The operation of the pixel comprises an alternance of PWM mode (A) and of data writing mode (B).

The data writing mode comprises a first period (E) followed by a second period (F). The first period (E) corresponds to the beginning of the data writing mode.

During the first period (E), the signal ROW, the voltage CTL and the voltages SW1 and SW3 are kept at a low value. The voltage SW2 is kept at a high value.

During the second period (F), the voltage CTL takes a low value, indicating, in this example, that the pixel is not in PWM mode. Furthermore, the voltages SW1, SW2 and SW3 respectively have a high value, a high value and a low value. The switches 115 and 38 are open. The switch 114 is closed The signal ROW1 corresponds to a clock signal for the writing of the data, received on the signal COL.

An advantage of the embodiments described is that the control circuit of the transistor 36 is simplified, which make it less costly and smaller. In particular, the analog part of each pixel is decreased.

Another advantage of the embodiments described is that the control circuit is a passive device, which decreases the static current.

Another advantage of the embodiments described is that the voltage VGS is generated based on the voltages ROW and COL.

Another advantage of the embodiments described is that it possible to simply optimize the voltage VGS, and therefore to calibrate each pixel independently.

An advantage of the embodiments described above is that it is possible to vary the capacitive values of the capacitive divider of each pixel. The capacitive voltage divider can be used to calibrate a pixel, for example using trimming. It allows the compensation of the variations of efficiency from one pixel to another. By correcting individually the pixels, it is possible for all pixels to emit the same level of light. Such homogeneity can not be obtained by a non-variable capacitive voltage divider such as the divider disclosed in US20170084220, as it is not possible to calibrate the pixels individually. Indeed, application of a different variable voltage to the input of the divider of each pixel is not possible. Typically, display pixels are distributed in an array and the voltage applied on the divider is the same for several pixels, for example for all the pixels of a line of the display array of pixels, as they receive the same signal.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove. In particular, there exists several ways to implement a capacitive voltage divider comprising two capacitive branches, the proportion between the two branches being variable, the divider being configured to ensure that the dividing ratio between the two branches is modified by the modification of the capacitive value of at least one of the branches. An example of such a divider 106 is described in the present description. However, this description of such a divider is not limiting, as those skilled in the art could conceive a capacitive voltage divider having the same functional features and a different implementation.

1. A pixel comprising:
a light emitting element and a first transistor coupled in series between a reference node and a supply node; and
a first circuit comprising a first terminal coupled to the control terminal of the first transistor, a second terminal coupled to the reference node, the first circuit being configured to generate a control voltage on the first terminal, the first circuit comprising a variable voltage divider configured to provide the control voltage on the first terminal, the variable voltage divider comprising two capacitive branches, the ratio of the capacitance values between the branches being variable; and
a first switch coupled between the first terminal of the first circuit and a conductive terminal of the first transistor.

2. Pixel according to claim 1, wherein the voltage divider comprises a first capacitor coupled between the first and second terminals of the first circuit.

3. Pixel according to claim 1, wherein the first circuit comprises a third terminal coupled to a node of application of a data signal.

4. Pixel according to claim 3, wherein the voltage divider comprises a second capacitor coupled between the first terminal of the first circuit and the third terminal of the first circuit.

5. Pixel according to claim 4, comprising a second switch coupled between the second terminal of the first circuit and a third switch coupled between the second capacitor and the third terminal of the first circuit.

6. Pixel according to claim 3, wherein the voltage divider comprises at least one third capacitor, the third capacitor being configured to be coupled between the first terminal and either the second or the third terminal, depending on a control voltage.

7. Pixel according to claim 6, wherein each at least one third capacitor is coupled in series with a fourth switch, one terminal of the second capacitor being coupled to the first terminal of the first circuit, the second terminal of the second capacitor being coupled to a first terminal of the fourth switch, the fourth switch comprising a second terminal coupled to the second terminal of the first circuit and the fourth switch comprising a third terminal coupled to the third terminal of the first circuit.

8. Pixel according to claim 7, wherein the first circuit comprises at least two assembly of a second capacitor coupled in series with a fourth switch, the fourth switches being controlled by different control voltages.

9. Pixel according to claim 1, wherein the first transistor and the element are coupled in series with a fifth switch.

10. Pixel according to claim 1, wherein the first circuit comprises a sixth switch coupled between the control terminal of the transistor and a node of application of a reset voltage.

11. A display screen comprising a plurality of pixels according to claim 1.

12. Display screen according to claim 11, wherein the pixels are disposed in an array and the third terminal of each first circuit is configured to receive a voltage common to all the pixels of a same row.

13. Display screen according to claim 11, wherein the light emitting elements are coupled with a common cathode, the elements of each pixel being coupled between the first transistor of said pixel and the reference node.

14. A method of controlling a pixel according to claim 1, comprising:
a first phase during which the first switch is closed and the capacitors of the voltage dividers coupled between the first and second terminals of the first circuit are charged, and
a second phase during which the first switch is open.

15. Method according to claim 14, comprising an alternance of first and second phases.
